(19) United States
(12) Patent Application Publication
(10) Pub. No.: US 2014/0095222 A1
(43) Pub. Date: Apr. 3, 2014

(54) METHOD AND SYSTEM FOR BUNDLING LODGING RESERVATIONS WITH SECONDARY GOODS OR SERVICES

(71) Applicant: Order Inn, Inc., Las Vegas, NV (US)

(72) Inventor: Eric Sutcliffe, Las Vegas, NV (US)

(21) Appl. No.: 14/037,820

(22) Filed: Sep. 26, 2013

Related U.S. Application Data
(60) Provisional application No. 61/706,909, filed on Sep. 28, 2012.

(51) Int. Cl. G06Q 10/02

(52) U.S. Cl. CPC G06Q 10/02
USPC 705/5

(57) ABSTRACT

A method and system are provided for bundling primary goods or services offered by a first entity with secondary goods or services offered by a second entity. Using the system, lodging services (such as in the form of a lodging reservation) may be bundled with food (such as food or meal vouchers), whereby a customer may make a single reservation that includes a room reservation from a lodging provider and a food/meal voucher associated with a food services provider, such as for a single price. The system may access an existing lodging or other reservation system and bundle the secondary goods or services in accordance with specified rules to create bundles which are offered to customers.

### RELATED APPLICATION DATA

This application claims priority to U.S. Provisional Patent Application Ser. No. 61/706,909, filed Sep. 28, 2012.

### FIELD OF THE INVENTION

The present invention relates to lodging reservation systems.

### BACKGROUND OF THE INVENTION

There are a number of drawbacks associated with the goods and services offered by existing lodging providers (such as hotels and motels). First, not all lodging providers are capable of offering related secondary services such as food services. Second, existing lodging reservation systems have limited functionality.

Due to the functionality of the Internet, most lodging providers such as hotels and hotel chains now operate on-line customer reservation systems that permit a customer to check room availability and reserve one or more rooms. Common lodging customer reservation systems generally comprise at least one lodging reservation server which is configured to display one or more web pages to customers who access a website supported by the server. The customer reservation system includes a database of available rooms, room rates, room reservation dates and related data. For example, a hotel may have a single presidential suite. The database may thus contain data relating to the presidential suite, including what days it is available, what days it is reserved and the rates for particular days (for example, the rates for weekends may be higher than for weekdays).

In operation, the customer utilizes a web-enabled computing device (such as a desktop or laptop computer or a tablet, PDA or the like) to access the lodging provider's website. The customer reservation server sends back information to the customer which causes a web page to be displayed on the user's device. This web page may include graphical information which allows a user to input information, such as a desired room type and desired room reservation dates. Upon input of such information, the customer reservation system determines the availability of rooms and presents information about available rooms (if any), rates, etc.

The customer may then reserve one or more rooms, such as by inputting required reservation information and payment information. The reservation information is maintained by the customer reservation system and upon completing the reservation, the room database is updated to reflect the status of the room as reserved for the indicated dates (to thus remove the room as available to other customers).

While such electronic reservation systems have greatly simplified the room reservation process (such as, for example, compared to old systems in which reservations were maintained in a log book and a customer had to call a hotel reservation clerk in order to place a reservation), such systems have a number of drawbacks. One drawback is that such systems are specifically designed to only implement room reservations, while a particular hotel may offer a number of other goods and services.

Another problem that existing lodging providers encounter is offering a full range of lodging-related services. For example, many hotels and motels do not have an associated restaurant. However, guests often do not have transportation so that they can travel to an off-site restaurant, may not have an expense account to pay for the food (in the case of guests who are traveling for work) or may find it undesirable to attempt to locate a suitable off-site restaurant (since this may require driving around looking for restaurants and/or attempting to determine if a located restaurant is suitable).

### SUMMARY OF THE INVENTION

Aspects of the invention comprise methods and systems for bundling primary goods or services which may be offered by a first entity, with secondary goods or services which may be offered by a second entity.

In a preferred embodiment of the invention, lodging services (such as in the form of a lodging reservation) may be bundled with food or food services (such as represented by food or meal vouchers), whereby a customer may make a single reservation that includes a room reservation from a lodging provider and a food/meal voucher associated with a food services provider(s).

In one embodiment of a system, a premium services provider system comprises a bundling server which obtains information regarding primary goods or services and secondary goods or services and creates bundles of the primary goods or services and the secondary goods or services. Information regarding primary goods or services may be obtained from an existing server or system which is associated with the primary goods or services provider. For example, lodging service information may be obtained from a lodging provider's existing customer reservation system. Information regarding secondary goods or services may similarly be obtained from a system associated with a secondary goods or services provider, such as a database of food vouchers.

Preferably, the bundling server creates bundles of at least one primary good or service with at least one secondary good or service based upon one or more defined rules. Information regarding bundles may be stored for later access or may be created upon request.

In one embodiment, a bundling website offers a customer the opportunity to make selections of various bundles. For example, a customer may make a reservation of a bundled lodging reservation and food voucher. Preferably, the bundle is offered at a single combined or unified price. The price may reflect a discount as compared to the sum of the individual prices of the goods or services if they were obtained separately.

Further objects, features, and advantages of the present invention over the prior art will become apparent from the detailed description of the drawings which follows, when considered with the attached figures.

### DESCRIPTION OF THE DRAWINGS

FIG. 1 schematically illustrates one embodiment of a system of the present invention; and

FIGS. 2A-2E illustrate examples of graphical user interfaces relative to the practice of a method of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Brief Overview

One embodiment of the invention is a method and system for bundling primary goods or services with secondary goods or services. Preferably, the primary goods or services and the secondary goods or services are offered, supplied or associated with different entities. For example, primary goods or services may be offered or supplied by a first entity, while secondary goods or services are preferably offered or supplied by a second entity. The primary entity, the secondary entity or an entirely different third entity preferably creates one or more bundles of primary goods and services and secondary goods and services. In other embodiments, the bundling system and method may be used to bundle goods or services associated with a single entity.

As described below, in one embodiment of the invention the primary service may comprise lodging offered by a lodging provider and the secondary good or service comprises food, such as represented by a food voucher. Thus, in a preferred embodiment, lodging services (such as in the form of a lodging reservation) are bundled with food or food services (such as in the form of food vouchers).

Preferably, the bundled goods and services are offered for purchase. In the case of lodging and food, a customer may make a single reservation which includes a lodging or room reservation bundled with a food/meal voucher. In this configuration, the system and method of the invention permit a lodging provider which does not have onsite food services to offer lodging services with a voucher which offers the guest food supplied by a secondary vendor.

Of course, as detailed below, lodging services might be combined with other secondary services. Further, the primary goods or services may comprise other than lodging services.

In a preferred configuration of the invention, bundling of lodging reservations and a secondary good or service is accomplished using an automated bundling system. The system obtains information regarding primary goods or services, such as information regarding available rooms from a lodging provider's reservations system, obtains information regarding one or more secondary services, and using various rules and a bundling engine, creates bundles of lodging and the secondary good or service in an automated fashion.

Bundling System

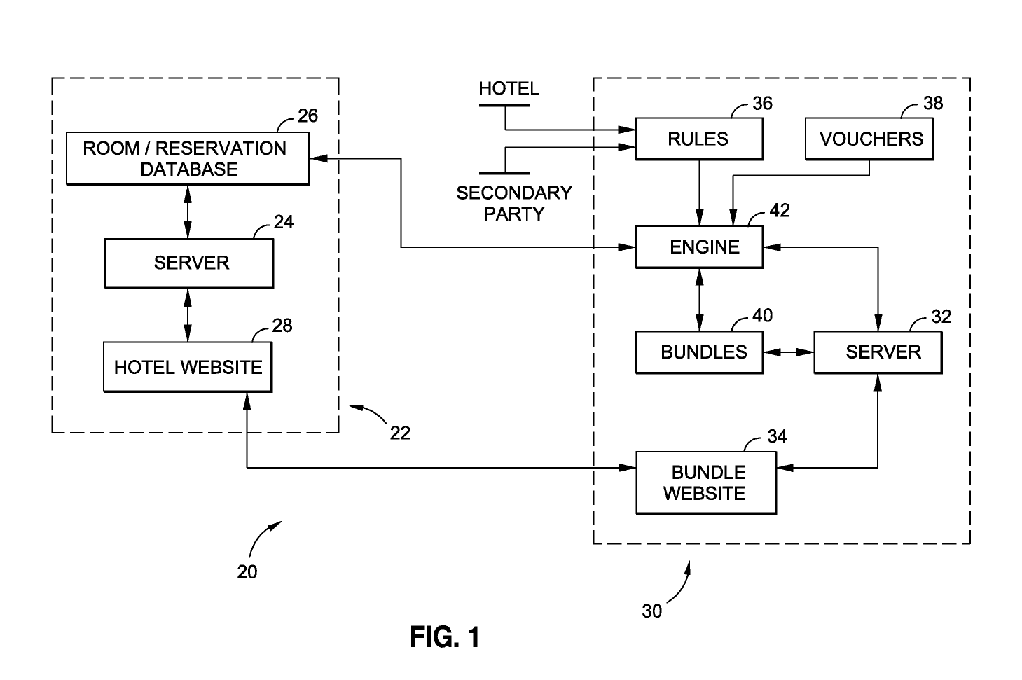

FIG. 1 illustrates one embodiment of a system 20 in accordance with the present invention. In one embodiment, the system 20 comprises a bundling system.

As illustrated, the system 20 includes at least one customer reservation system (CRS) 22 which is associated with one or more lodging providers. As indicated below, such a lodging provider might be an entity, such as a “chain”, which operates multiple lodging properties, or might comprise individual lodging providers/locations. The lodging CRS 22 might be operated directly by the lodging provider or via one or more third parties.

In one embodiment, the lodging CRS 22 includes at least one CRS server 24. The lodging CRS server 24 is preferably configured to host a lodging reservation website 28. Such a website 28 may have various forms, including offering various content and features. Preferably, the website 28 presents information regarding one or more rooms offered by the lodging provider which are available for reservation and permits a user into input reservation information.

In one embodiment, lodging CRS server 24 comprises a computing device which comprises means for generating response data or information. Such means may comprise at least one processor. The processor is configured to generate reservation information, graphical user interfaces (web pages), etc., such as based upon the execution of machine readable code (i.e. software). Of course, the processor could also be pre-programmed or configured as hardware configured to generate variations of the data.

In one embodiment, the lodging CRS 22 includes means for storing information and/or instructions. Such means may comprise one or more memory devices. Such might comprise RAM, ROM (including EPROM, EEPROM, PROM) or other devices now known or later developed. The lodging CRS server 24 might include one or more other memory devices, such as for storing software or the like, as detailed below. For example, in one embodiment, the lodging CRS server 24 might include or be in communication with one or more mass data storage devices, such as one or more hard drives or the like.

In one embodiment, the lodging CRS 22 includes at least one database 26 of room information. For example, the room database 26 may include data regarding the rooms at the hotel, including which rooms are available and which ones are reserved on certain days/times, the room reservation rates for each room (which rates may vary by time), guest reservation information including guest name(s), addresses, payment information and the like. Of course, the room database 26 may store or include a wide variety of information in a wide variety of forms.

The lodging CRS server 24 preferably also includes at least one communication interface, by which the lodging CRS server 24 may receive and transmit information. The communication interface(s) may permit communications in accordance with various protocols and in various forms. In one embodiment, the communication interface may be configured so that the server 24 may transmit and receive data in accordance with a TCP/IP protocol over a wired network link with the Internet.

The lodging CRS server 24 might actually comprise a system or network of a plurality of elements or devices. For example, the lodging CRS server 24 might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the lodging CRS server 24, such as to change operator settings and the like. The lodging CRS server 24 might also comprise a router and one or more separate computing devices. The functions of the various computing devices might be segregated.

In operation, the lodging CRS server 24 is preferably configured to support a hotel room reservation website 28. For example, upon a user accessing the lodging provider's website 28, the CRS server 24 may be configured to cause the user's computing device to display a graphical user interface or webpage. Such an interface may display various information regarding the hotel and rooms which are available for reservation. The lodging CRS server 24 is likewise preferably configured to receive information from a user, such as input regarding dates during which the user would like to reserve a room, the type of room, number of guests per room, etc. Based upon such information, the lodging CRS server 24 may check room availability and transmit information regarding available rooms and rates, etc. Likewise, the lodging CRS server 24 may receive input from a user regarding guest identity information and payment information.

In the case of a CRS system 22 which relates to multiple hotels or properties (such as in the case of a lodging provider which operates a number of individual hotels, for example), the CRS system 22 may connect to or gather information from one or more individual sources. For example, a hotel chain operator's CRS system 22 may poll individual hotels of the chain for current room availability and pricing and that information may be associated with an integrated database of the CRS system 22 which contains information regarding all of the hotels.

The CRS system 22 may be operated by a lodging provider or by a third party. For example, as indicated above, an individual hotel might operate such a system or a system might be operated by an entity having multiple properties. In other embodiments, the CRS system 22 might actually be operated by a third party.

Preferably, the system 20 includes a premium services provider system 30. In general, the premium services provider system 30 is configured to obtain information regarding one or more primary goods or services and one or more secondary goods or services and, in an automated fashion, bundle them. In a preferred embodiment, as detailed below, the premium services provider system 30 is configured to obtain information from a lodging CRS 22 and use separate information regarding one or more secondary goods or services and, based upon various criteria, create one or more bundles of lodging/room reservations and a secondary good or service.

As one example, the premium services provider system 30 may include at least one bundling server 32. The bundling server 32 is preferably configured to host one or more bundle websites 34. Such a website 34 may have various forms, including offering various content and features as described below. Preferably, the bundle website 34 presents information regarding combinations or “bundles” of primary and secondary goods/services, and most preferably, lodging and one or more secondary goods and/or services. In a preferred embodiment, the one or more secondary goods and/or services comprise food, such as in the form of one or more food/meal vouchers. The bundle website 34 is also preferably configured to receive information from a user for the purpose of making a reservation/purchasing a bundle.

The premium services provider system 30 preferably also includes one or more data storage devices. Such devices may be part of the bundling server 32 or be separate there from. As described below, the one or more data storage devices may be configured to store rules 36, such as in a rules database, voucher information 38, such as in the form of a voucher information database, bundle information 40, such as in the form of a bundle database, and computer readable/executable code (“software”) for execution by the bundling server 32.

In one embodiment, the premium services provider system 30 also includes a bundling engine 42. The bundling engine 42 may comprise, for example, software which is executed by the bundling server 32 or another computing device. As described below, the bundling engine 42 is preferably configured to use the rules 36 to create bundles 40 based upon voucher information 38 and lodging/room data.

The rules 36 preferably comprise information which is used by the bundling engine 42 in determining the criteria for bundling primary goods and services with secondary goods and services. In one embodiment, a rules database stores one or more rules 36 which comprise information regarding how the bundling engine 42 should create one or more bundles. A bundle comprises a combination of at least a primary good or service with at least one secondary good or service. In a preferred embodiment, a bundle comprises a combination of a lodging service (such as represented by a lodging reservation) along with food or a food service (such as represented by a food voucher). Information regarding such bundles 40 may be stored in a bundles database.

As indicated, the rules 36 which are stored in the rules database may comprise information which is provided by a hotel and/or a secondary party (the premium services provider or a third party).

Information regarding one or more vouchers 38 may be stored in a voucher database. For example, in the case where the secondary good/service comprises food, the vouchers database 38 may store information regarding food/meal vouchers. Such a food vouchers may represent food which a user is entitled to obtain, as described in more detail below.

Additional aspects of the invention will be appreciated from a description of the operation of the system and one or more examples.

Still referring to FIG. 1, in accordance with a method of the invention, a premium services provider may bundle one or more secondary goods or services with one or more primary goods or services. In the preferred embodiment, the primary service comprises lodging and the secondary good comprises food. In a preferred embodiment of the invention, a customer may reserve or purchase the bundled goods/services.

As illustrated, the bundle engine 42 preferably obtains information regarding available lodging, such as one or more hotel/motel rooms, from a lodging provider's CRS 22, including the room/reservation database 26. In this regard, at one or more times a communication link may be provided between a lodging provider's CRS 22 and the premium service provider system 30.

The bundling engine 42 also obtains information regarding one or more food vouchers 38. The bundling engine 42 then generates one or more bundles based upon the rules 36 (such as stored in a database).

As one example, Hotel A may allow a premium services provider to bundle a queen bed room with a $20.00 meal voucher. Hotel A may input or provide rules 36 by which Hotel A allows such bundling. The bundling engine 42 accesses Hotel A's room/reservation database 26 to obtain information regarding the queen bed rooms and the associated rates. The bundling engine 42 also accesses information regarding $20.00 meal vouchers 38, such as from a voucher database. The bundling engine 42 then creates one or more room and food bundles. For example, a queen bed room from Hotel A on September 1 may be priced at $65.00. Hotel A may desire to bundle on a $20.00 meal voucher at a $10.00 overall discount (as determined by the rules 36), such that the bundle comprises a queen room and $20.00 meal voucher for a price of $75.00 on September 1.

Of course, it will be appreciated that different rooms may have different prices and the same room may have different prices depending upon the day of the week or the like. The bundling engine 42 preferably accesses and utilizes the room information directly from the lodging provider's CRS 22 in generating the bundles, thus reflecting the lodging provider's own room information.

Likewise, various rules may be applied when generating a bundle. For example, a hotel may set rules regarding the total bundle price, the amount of discount to be applied to the total price in generating the bundled price, what rooms a bundle may be applied to, what days or times a bundle may apply to and a wide variety of other rules.

While the system 20 illustrated in FIG. 1 only shows a link between a single lodging provider's CRS 22 and a premium service provider system 30, the premium service provider system might be linked to multiple lodging CRSs 22, such as those of Hotel A, Hotel B, etc. In this manner, different bundles may be generated which correspond to the different lodging providers.

It will also be appreciated that the system 20 which is illustrated in FIG. 1 is just one embodiment of a system which could be used to implement the invention. For example, a premium service provider system 30 might have other configurations and still be capable of obtaining information regarding primary and secondary goods and services and then creating bundles in an automated fashion. Thus, while FIG. 1 illustrates a bundling system 20 which is particularly configured to bundle lodging reservations with food vouchers, the system 20 might have other configurations depending upon the goods and services which are being bundled. For example, as detailed below, in the case of bundling of car rental reservations, a premium service system might be configured to link to a car rental company's reservation system.

In addition, as described herein, while one entity may run or operate the lodging provider CRS 22 and another entity may run or operate the premium service provider system 30, the portions of the bundling system 20 could be combined so as to be operated by a single entity. In another embodiment, second entity might operate a voucher or other system and a third entity (different than the first entity which provides the lodging or other primary good or service or the second entity which provides the food or other secondary good or service) might operate the premium services system 30.

Example Implementation

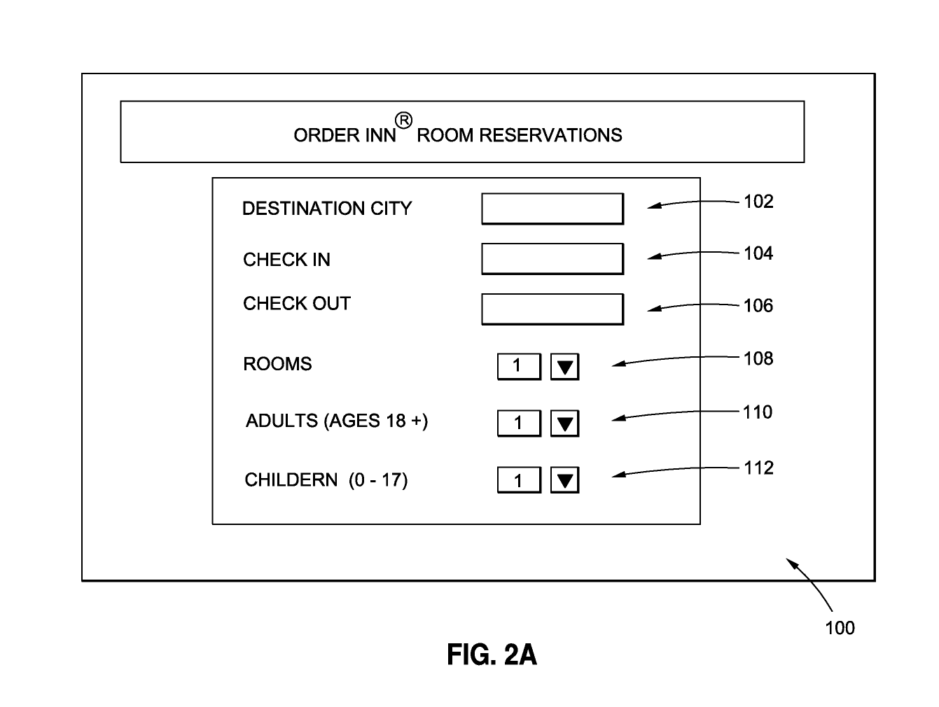

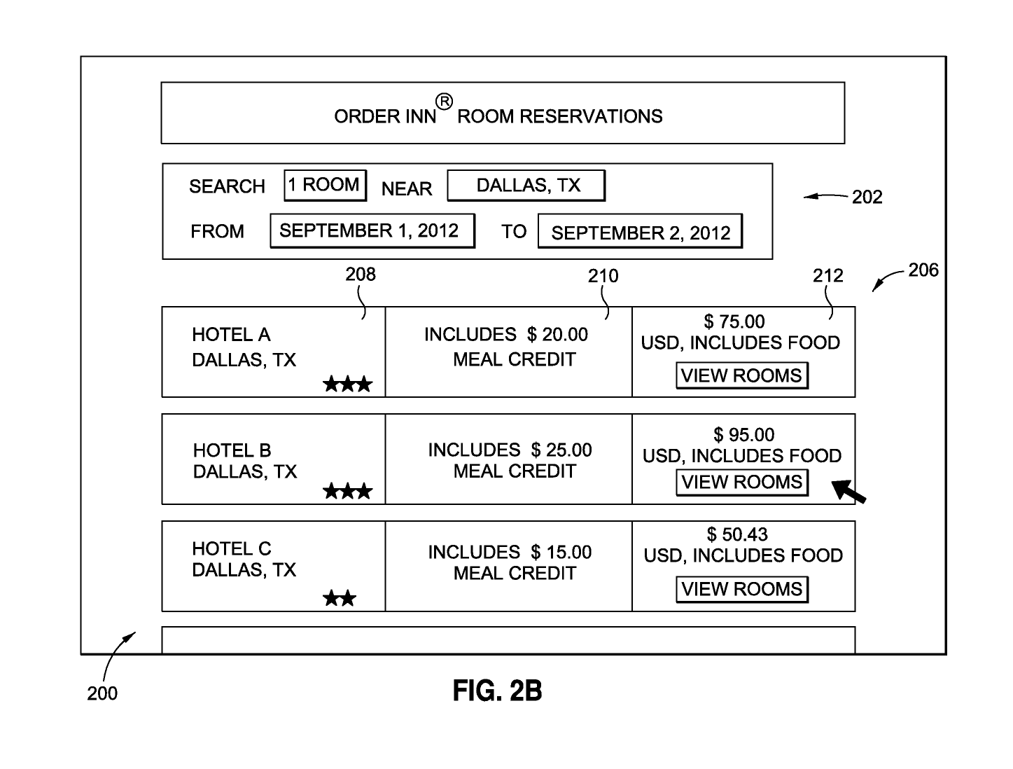

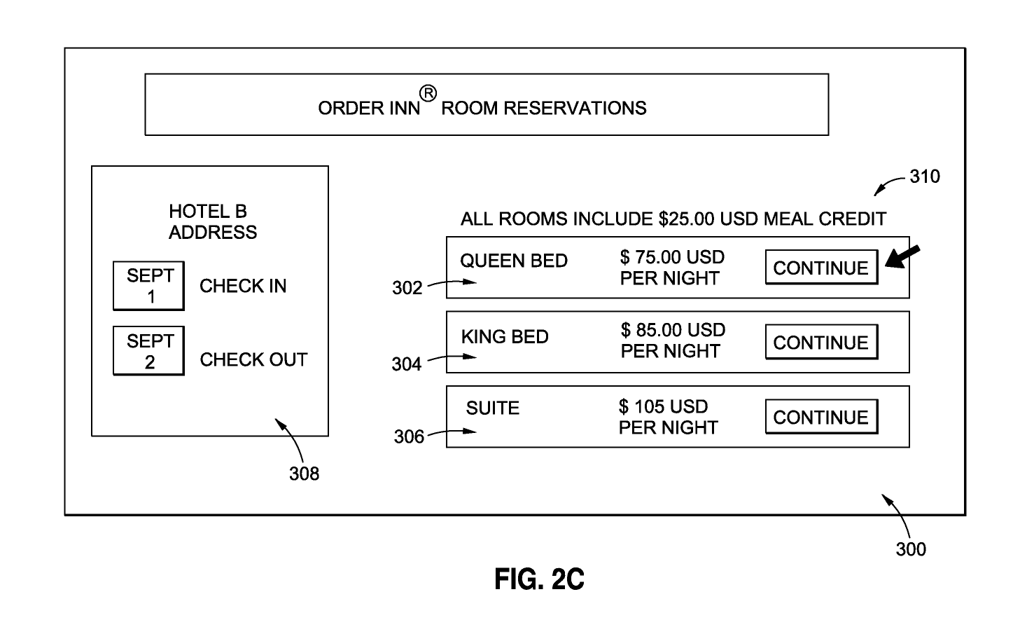

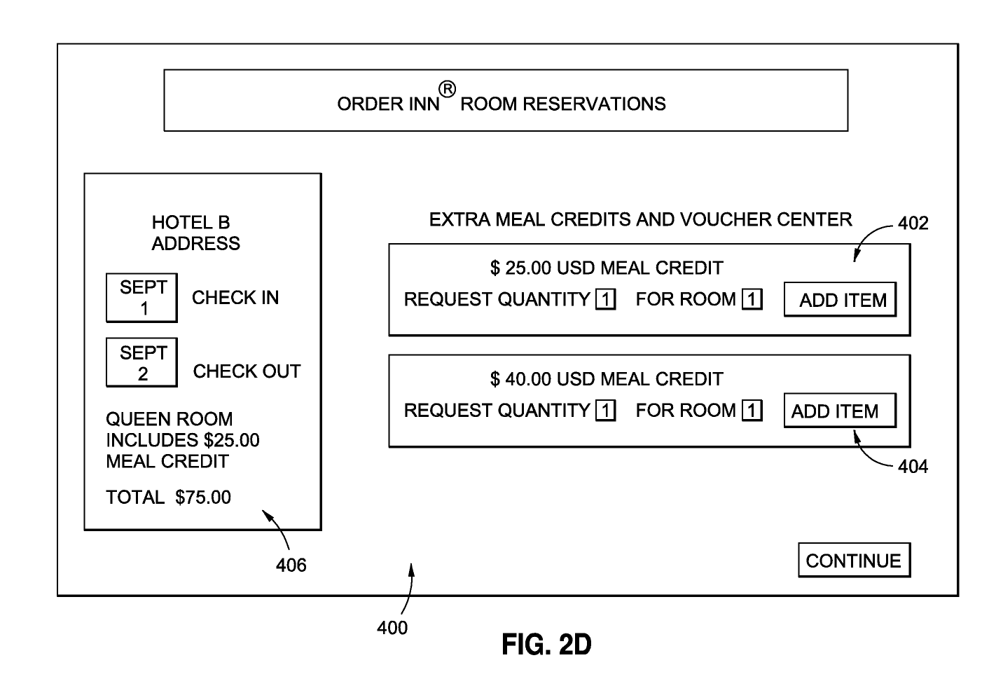

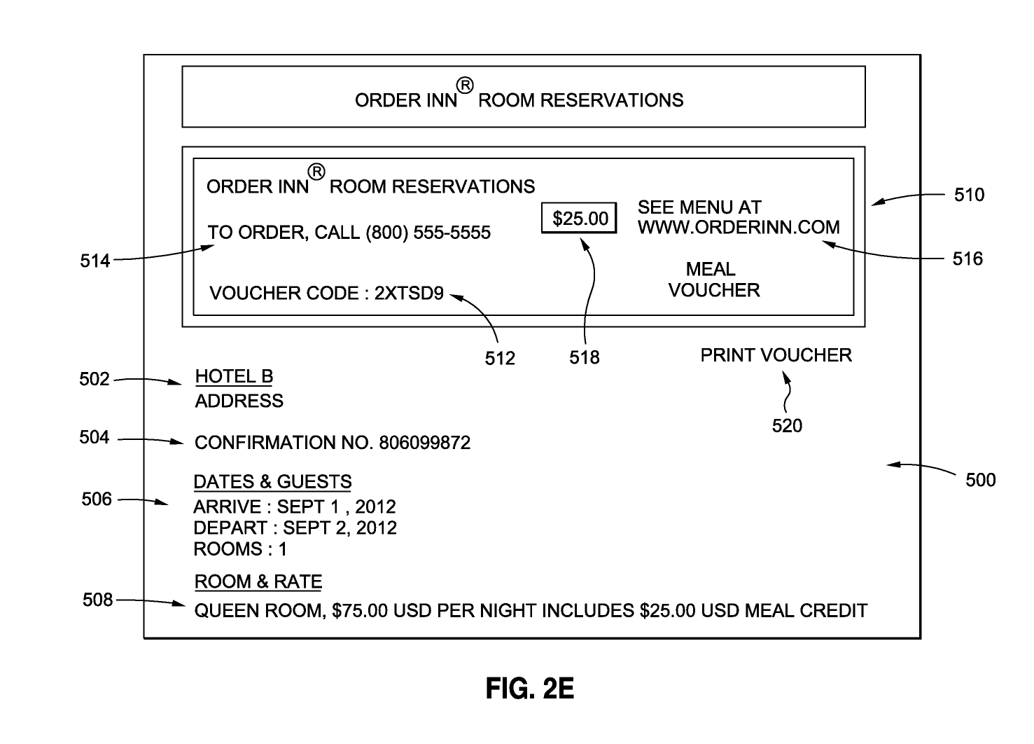

One particular example of the invention will be described with reference to FIGS. 2A-2E. As illustrated in FIG. 2A, the premium services provider Order Inn may operate a premium services system 30, including associated an associated Order Inn Room Reservations website 34.

As illustrated, the website 34 may be supported by one or more bundling servers 32 which cause a first graphical user interface 100 or “home page” to be displayed on a display associated with a user's computing device. The first graphical user interface 100 may display various information regarding the goods and services offered at the website. In one embodiment, the information may include one or more fields via which a user may input information. For example, as illustrated, first graphical user interface 100 may include a destination field 102, such as to permit a user to input or select a desired destination at which lodging is desired. Such a field 102 may permit input or selection of a city, state, country, county or other information which designates a destination.

The first graphical user interface 100 may also include a check-in field 104, such as to permit a user to input or select (such as via a displayed calendar) a desired check-in date or starting date for the reserved services. For example, the check-in field 104 may permit a user to input or select a particular day, month and year (or other time). Likewise, the first graphical user interface 100 may also include a check-out field 106, such as to permit a user to input or select (such as via a displayed calendar) a desired check-out date or ending date for the reserved services.

Relative to a lodging reservation, the first graphical user interface 100 may also include an “adults” field 110 for indicating or selecting a number of adults for whom the services are intended to be provided. Likewise the first graphical user interface 100 may include a “children” field 112 for indicating or selecting a number of adults for whom the services are intended to be provided.

As one example, the user might input the destination “Dallas” for a trip to Dallas, Tex., USA. The user might input a check-in date of Sep. 1, 2012 and a check-out date of Sep. 2, 2012 and select a single (1) adult and zero (0) children.

The user's input(s) are directed to the bundling server 32 which preferably conducts a search of the bundles in the bundles database 40 to determine if any bundles are responsive to the user's request. In this example, the bundling server 32 preferably checks the bundles database 40 for bundles of rooms and meal vouchers which meet the requirement of lodging in Dallas, Tex. with available rooms on the designated check-in and check-out dates, for a single adult.

As illustrated in FIG. 2B, the bundling server 32 may locate multiple responsive results. In this example, the bundling server 32 has located Hotels A, B and C which all have room bundles which meet the user's requirements. As illustrated in FIG. 2B, the bundling server 32 may cause the user's computing device to display a second graphical user interface 200 or “initial results page.” The second graphical user interface 200 may be configured to display responsive results to the user's inquiry.

For example, the second graphical user interface 200 may display information which confirms the user's inputted request/query 202. The second graphical user interface 200 may also display relevant results (if such exist, if no responsive results were obtained, the user might be so informed). As illustrated, results were obtained for Hotel A, Hotel B and Hotel C. In one embodiment, the results identify the location at which lodging is available, the secondary good/service which is bundled with the lodging, and the total price of the bundle/package.

For example, a first result 206 includes information which identifies Hotel A 208 as the lodging provider (which information may include the name of the lodging provider, the location—such as Dallas, Tex., the address, and/or other information), the bundled secondary good or service 210 such as a $20.00 meal credit, and the total price of the bundle/package 212, such as $75.00. Similar information may be similarly provided relative to other results.

In one embodiment a user is given available options for bundles, including a choice of lodging by location and/or provider, total package price, and one or secondary goods/services. The user may then make a selection of one of the results. As illustrated, the user has used a cursor to select the package offered by Hotel B.

In one embodiment, in response to the user's selection of particular lodging, the user may be given additional options. For example, as illustrated in FIG. 2C, the bundling server 34 may cause the user's computing device to display a graphical user interface 300 which shows lodging options from the selected provider. Of course, these options may vary depending upon the particular lodging provider. In this example, the bundling server 34 has determined that three bundles from the selected lodging provider meet the user's criteria: (1) a queen bed room at a bundled price of $75.00/night 302; (2) a king bed room at a bundled price of $85.00/night 304; and (3) a suite at a bundled price of $105.00/night 306. As illustrated, along with each of these selections, information may be displayed 310 regarding the one or more associated or bundled secondary goods or services.

As illustrated, the graphical user interface 300 may display additional information, such as information which reflects the user's selected lodging provider and desired check-in and check-out dates 308. In this example, the user has selected the queen bed option 302, such as by clicking a “continue” button with a cursor.

As illustrated in FIG. 2D, the user may be given other or additional options. As illustrated, the bundling server 34 may cause the user's computing device to display a graphical user interface 400 of secondary goods/services options.

For example, the user may be given the option of adding one or more secondary goods or services to the selected bundle. For example, relative to a bundle which includes a room and food (such as a meal voucher), the user may be given the option to purchase additional food. As illustrated, the user has been given the option of purchasing one or more matching food/meal vouchers 402 (i.e. where the bundle included a $25.00 meal voucher, the user has been given the option of purchasing another $25.00 meal voucher). As illustrated, the user has also been given the option of purchasing one or more different or upgraded meal vouchers, such as a $40.00 meal voucher 404.

Once again, the graphical user interface 400 may display additional information, such as information which reflects the user's previously input information and/or selections, such as the user's selected lodging provider, check-in and check-out dates and selected room option 406.

After the user has made any selections of additional options, if any, the user may continue the purchase/reservation process. Though not illustrated, similar to standard website purchase processes for other goods and services, after a user's final selection of items, the bundling server 34 may cause one or more graphical user interfaces to be displayed by the user's computing device which prompt the user for check-out or purchase information. These one or more graphical user interfaces may provide fields for the user to input their name, billing address, residence/mailing address, telephone, fax number, email address and the like, as well as to provide payment information such as credit card information.

Once the user has provided any requested user identity and/or payment information, the bundling server 34 may cause the user's computing device to display a receipt page/interface 500. This interface 500 may, for example, provide information to the user regarding the name and address of the lodging provider 502 at which the lodging has been reserved, the lodging confirmation number 504, the check-in and check-out dates and number of guests 506 and the lodging rate and associated bundled good/service 508.

In addition, the interface 500 may display information regarding the bundled secondary good or service, such as the above-described meal voucher 510. In one embodiment, an image of the meal voucher 510 is displayed. This image may include information regarding the meal voucher 510, such as a unique voucher code 512, contact information for redeeming the voucher such as a telephone number 514 and/or website address 516 or locations where the voucher may be redeemed, and information regarding the value of the voucher 518. In one embodiment, a user could write down the voucher code 512 and use that code in order to redeem or use the voucher, or the user might use a print function/icon 520 to cause the voucher 510 to be printed on physical media, such as via a printer associated with the user's computing device.

Relative to the specific example just described, the user has reserved lodging with a particular lodging provider on specified dates and may thus travel to the identified lodging location to use their reserved room. In addition, the user has received a bundled meal voucher. As described below, such a meal voucher may be used in many ways, but in one method the user may use the voucher during the user's stay, such as by ordering food for delivery to the user's room or by travelling to a food service provider, wherein the meal voucher serves as full or partial payment for the ordered food.

Other Aspects of the Invention

Additional aspects of the invention will now be described.

In a preferred embodiment of the invention, lodging services are bundled with food or a food service. In one embodiment, the lodging and food are bundled as part of a reservation process whereby a customer may, via one reservation process, reserve both food and lodging.

Of course, the bundled lodging may have various forms. For example, the lodging may be provided by a hotel, motel, bed and breakfast, time share, vacation rental or other type of lodging provider.

It will also be appreciated that when the secondary good or service comprises food, elements other than vouchers might be used to designate the food or food service. For example, a credit card, debit card, gift card, currency, coupon or other element might be bundled with the primary good or service, such elements simply representing the food or food service.

A voucher might be redeemable in many ways, such as relative to a specifically identified food vendor (such as a hotel restaurant, outside restaurant or other food provider). In one preferred embodiment, the meal or food voucher may be redeemable via third party (i.e. different than the lodging provider and/or via a food service provider which is not at the site of the lodging), such as in the manner described in U.S. patent application Ser. No. 11/082,450, filed Mar. 17, 2005, which is incorporated herein in its entirety by reference. As disclosed therein, a broker may contract with one or more food service providers, such as restaurants, to affect a supply of food to guests of one or more lodging locations. As disclosed therein, the user may use an in-room menu to contact the broker, via which the user may place an order for food which is supplied by the third party food vendor associated with the broker, which order is monitored and quality-controlled via a food services broker. In one embodiment, the meal voucher may be supplied by the broker. This voucher may then be accepted by each food vendor associated with the broker. For example, when placing a food order via the food broker, the customer may provide the meal voucher code. The broker or food services provider may enter the voucher code into a computing device which checks the code with the server 34, thus verifying that it is available for redemption. If so, the value of the voucher may be credited against the cost of the user's food order as supplied by the third party food vendor. The voucher which is associated with the designated code is then preferably updated by the bundling server 34 to a “redeemed” or partially redeemed (such as showing a remaining value) status to prevent its subsequent redemption.

A bundled meal voucher may have various features or forms. For example, a bundled meal voucher may have a particular monetary-equivalent value, may be usable before a particular expiration date or on a certain day/date (or during a particular period of time), may be usable only at specified locations, or have other terms and conditions for use. As indicated above, a meal voucher may be generated electronically and be printable or may simply be represented by a voucher code. In other embodiments, a meal voucher may be emailed or mailed to a user. For example, a meal vouchers having an associated physical media such as in the form of a paper voucher/ticket, in the form of a card or the like, may be provided to the user.

As indicated above, a customer might be permitted to change attributes of the meal voucher, such as by paying to increase the value of the voucher. A customer might also be permitted to pay to change the expiration of the voucher. For example, when a single voucher is tied to a single lodging night reservation, the voucher might be usable only on the night of the lodging reservation. However, a customer might be permitted to pay to cause the voucher to be redeemable within 1 month of the lodging reservation date.

Preferably, the system 20 of the invention is configured to track the bundled goods/services, such as for redemption and auditing purposes. First, relative to a lodging/food bundle, the user's identity information and/or payment information may be saved by the bundling server 34, such as in one or more data files. In addition, the bundling server 34 preferably forwards such information to the lodging provider's CRS server 24 for storage in the lodging provider's CRS 22. In this manner, when the user travels to the lodging location to check-in, lodging provider personnel may verify the user's reservation directly with the provider's CRS 22.

In one embodiment, when a meal voucher is created, information regarding that voucher is stored in the system 30. In this manner, as described above, the voucher may later be identified, such as to determine whether or not it is available for redemption. As indicated above, the status of a voucher may be stored, such as to indicate whether the voucher: (1) is available for redemption; (2) is expired; or (3) was redeemed or partially redeemed (in the case, for example, where a voucher may be partially redeemed and thus have some remaining usable value).

Of course, the premium services system 30 may be auditable. For example, a user station which is in communication with the bundling server 34 may be used to audit reservation or other records. For example, such a user station might be used to determine the status of all vouchers for a particular period of time (i.e. which ones have been redeemed, which have expired and which are still active).

As indicated above, various rules 36 may be provided to the bundling engine 42. These rules may be determined by the providers of the bundled goods or services or otherwise. The rules may vary depending upon the provider and/or the goods/services. As one example, a particular hotel may input a rule that all bundled room and meal voucher prices are discounted by $10 from the standard price on weekdays and $20 on weekends (e.g. if the hotel's standard room rate is $70 and the bundled meal voucher is for $20, then the bundled price is discounted by $10 to $80 during weekdays and to $70 on weekends); the bundled prices may not be discounted on weekends, no bundling may be offered for certain rooms or on certain days, the bundling may be for specific combinations of rooms and vouchers, etc. It will be appreciated that the rules 36 may have various sources. For example, rules 36 may be provided or set by the provider of the primary good/service, the secondary good service, or a third entity such as a separate operator of the premium services system 30.

In one embodiment of the invention, a user may seek the bundled services by accessing the bundle website 34. In one configuration of the invention, such a website 34 may be “generic”, meaning that it may offer bundled goods and services from more than one party, such as Hotels A, B and C. In another embodiment of the invention, the website 34 may support a “white label” site, wherein a user may access particular web pages which offer bundles which are unique to one particular provider or which is unique to the customer. For example, a user might access a main or generic home page at www.orderinn.com. However, a user who only wants to reserve a bundle which includes lodging from Super 8 hotels might access a specific Super 8 page at www.orderinn.com/Super8. By accessing such a page, the user might only be offered bundles which include lodging offered by Super 8 hotels.

In another configuration, as illustrated in FIG. 1, in one embodiment the bundling website might be accessible from a provider's website. For example, the Super 8 hotel website 28 might include a link to the Super 8 bundle page at the bundle website 34. In that event, a customer seeking a Super 8 reservation at the Super 8 website might be presented with a link at that webpage which offers the customer the opportunity to “reserve lodging and food.” If the customer clicks on that link they may be directed to a Super 8 bundle webpage which is hosted by the bundled website 34. Preferably, that specific bundle page is “Super 8” specific and thus presents the customer only with bundles which include Super 8 lodging.

Lastly, the system 30 might be configured to offer or present customer-specific bundles. For example, a particular customer might desire only bundles of lodging from Hotel A and B with associated food vouchers. The customer might access the bundle website 34 and present a customer code. This code may cause the bundle website 34 to present a customer-specific menu or page and present only results which meet the customer's pre-designated criteria. In this regard, the bundling system 30 may be configured to present information in various fashions.

As indicated herein, the premium services provider system 30 may be operated by one or more parties, including a provider of secondary goods/services or a third party or third entity who bundles goods and services from primary and secondary entities (i.e. where the third party does not offer either the primary or secondary goods/services). For example, a lodging provider which already operates a CRS 22 might associate that system 22 with a premium services system 30 to thus create bundles of their lodging with one or more secondary goods or services in an automated fashion.

It will also be appreciated that the system 20 could be used to bundle other goods and services than those which are specifically detailed above. For example, a primary lodging service could be bundled with other secondary goods or service (other than food/food vouchers). In such event, information regarding vouchers 38 may be replaced by other information, such as show ticket information or the like. Likewise, other primary goods or services (than lodging or lodging reservations) might be bundled with food (such as food vouchers).

While the terms “primary” and “secondary” have been used herein to designate different goods and services, the use of such terms does not imply that one good or service is more important than the other, though in one configuration a primary good or service may be a main good or service and a secondary good or service may be one which relates to or is particularly applicable to, the primary good or service. However, the goods and services might simply be referred to as first and second goods and services or by other terminology.

A particular advantage of the invention is the ability of a party to offer bundles or combinations of at least one primary good/service with at least one secondary good/service, and particularly in the situation where the primary and secondary goods/services are provided by different entities. As one particular example, as noted above, many lodging providers do not have food service facilities. The lodging providers are at a disadvantage relative to “full service” lodging providers which do have food service capability, such as via an onsite restaurant. The limited service providers may thus work with a third party food service provider to bundle their lodging services with the food services offered by other parties. In this manner, a potential customer can reserve or purchase a bundle which offers them both lodging and food services.

A particular advantage of the invention is that the premium services system can be operated by a third party other than the primary service provider, such as the lodging provider. In this manner, the lodging provider does not need to entirely modify their existing customer reservation system to try and implement additional functionality. Instead, a third party can operate the premium services system 30 and can generate and offer the bundles while only needing to access existing information in the lodging provider's CRS database 26.

In this regard, the system 30 has particular applicability to other primary goods or services which are associated with a primary entity's reservation website. For example, the system 30 might connect to a car rental company's car reservation website and be used to bundle gasoline vouchers (such as from a petroleum company) with the car reservations.

Another advantage of the invention is that via the bundling, a customer may be offered a combination of at least one primary good or service with at least one secondary good or service as a package. In one embodiment, the bundle is offered at a single unified price rather than the customer having to separately purchase the goods or services from the separate providers of the primary goods and services. Preferably, the unified price can be presented at a discount as compared to the sum of the prices of the goods or services if they were to be obtained separately.

One particular advantage of the invention is that the bundling can be used to generate new and unique marketing opportunities. For example, as indicated above, a hotel which does not have on-site food service may now offer a customer a bundle of their lodging with a food service, thus making them competitive to full service lodging providers. In addition, different bundles might be created to generate different marketing opportunities. For example, a hotel in Miami might not offer a room and food bundle during winter months when demand for rooms is very high. However, in the summer when demand is lower, that hotel might offer a room and high value food voucher in order to attract guests.

As indicated, one advantage of the invention is that the bundle may be offered at a unified price which is less than the combine price of the two goods or services if they were purchased separately. For example, a hotel might normally offer a particular room at $100 per night but might offer a bundle of the room and a $20 food voucher at $100 so as to attract more customers. Of course, where the bundle is generated by a third party, various types of splits, commissions or the like might be applied. For example, a premium services provider might offer food vouchers which are useable at designated locations. Hotels which do not offer food services may allow the premium services provider to bundle their rooms/reservations with food vouchers in order to drive more guests to their hotel. In such event, the hotel might discount their room price so that when the premium services provider bundles the food voucher, the price of the bundle is less than the separate prices of the room and voucher. In other embodiments, some or part of the discounted price may be absorbed by the premium services provider. For example, in the case of a food voucher, some purchasers of vouchers may not use them and thus the premium service provider may bundle food vouchers at a discount knowing that profit will be realized do to the fact some vouchers are not used or the entire value of some vouchers are not used (for example, a hotel room may be offered at $90 normally and the premium service provider may offer a bundle of the room and a $20 food voucher at a price of $100; in that case the premium services provider might either ask the hotel to provide the room at $80 per night or the voucher provider might instead provide the $20 voucher at a paid cost of $10 by the customer).

The invention has particular advantages to customers. For example, many businesses require that their employees travel and thus need to provide their employees with food and lodging. As indicated, some hotels do not have food service. Thus, the employer may need to separately find a way to provide food services to their travelling employees. One way is to have the employee pay for food and then reimburse them. Some employees, however, baulk at having to pay out of pocket. Also, this system requires that the employer check reimbursement requests, receipts and the like for valid payment, all of which is time consuming and cumbersome. Alternatively, the employer might provide the employee with a credit card. However, in that event the employer might use the card to purchase items other than food.

In accordance with the invention, a company can reserve rooms and food as a bundle. First, when the food is purchased in the form of a food voucher that is redeemable or usable only via an authorized food supplier, the employee can only use the food voucher for the redemption of food. Second, bundling of the voucher eliminates the need for the employer to separately issue a credit card or reimburse the employee. Instead, the employer only needs to provide the voucher or the voucher code to the employee.

Using the system, such a company may also be provided with voucher reports that enable the company to track which vouchers were redeemed, partially redeemed or not used. This helps the company audit when vouchers are necessary, the best voucher price-point/value and the like.

As indicated herein, the system and method are applicable to other types of goods and services. Thus, various of these types of advantages or other advantages may be realized as a result of bundling of other types of goods and services.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A reservation bundling system comprising:
a rules database defining one or more bundling rules;
a secondary goods/services database containing information regarding at least one secondary good/service;
a bundling engine, said bundling engine configured to receive lodging information from at least one lodging provider's customer reservation system and to receive information from the secondary goods/services database and, based upon the bundling rules in the rules database, create at least one bundle of lodging combined with at least one secondary good/service;
a bundling database configured to store information regarding created bundles; and
at least one server which is configured to host a bundle reservation website via which a user may select one or more of said bundles.

2. The reservation bundling system in accordance with claim 1 wherein said secondary good/service is represented by a voucher and said bundle comprises a combination of lodging and at least one voucher.

3. The reservation bundling system in accordance with claim 2 wherein said at least one server is configured to transmit a voucher code to said user, said voucher code corresponding to a voucher associated with a bundle purchased by said user.

4. The reservation bundling system in accordance with claim 3 wherein said at least one server is configured to receive said voucher code from a services provider in response to presentation of said voucher by said user to said services provider for redemption, and wherein said at least one server is configured to validate said voucher code against a stored voucher code corresponding to said voucher.

5. The reservation bundling system in accordance with claim 1 wherein said voucher is redeemable for food.

6. The reservation bundling system in accordance with claim 1 wherein said voucher is redeemable for transportation services.

7. The reservation bundling system in accordance with claim 1 wherein said lodging has a first price, said at least one secondary goods/service has a second price and said bundle has a third price which is less than the sum of said first price and said second price.

8. The reservation bundling system in accordance with claim 1 wherein said lodging information comprises room availability and room pricing.

9. The reservation bundling system in accordance with claim 1 wherein each bundle has a price.

10. The reservation bundling system in accordance with claim 1 wherein said at least one server is configured to transmit a lodging reservation to said customer reservation system corresponding to lodging associated with a bundle selected by said user.

11. A method of offering bundles of lodging services and at least one secondary good/service via at least one computing device comprising the steps of:
obtaining electronic information comprising lodging information from at least one lodging provider's customer reservation system;
creating one or more bundles of lodging with at least one voucher for at least one secondary good or service based upon one or more bundling rules;
transmitting information regarding one or more of said bundles to a user for selection by said user in response to a query by said user; and
if said user selects a bundle:
transmitting lodging reservation information to said customer reservation system corresponding to lodging associated with said bundle selected by said user; and
transmitting a voucher code to said user corresponding to an issued voucher associated with said bundle selected by said user.

12. The method in accordance with claim 11 wherein said issued voucher is redeemable for food.

13. The method in accordance with claim 11 wherein said issued voucher is redeemable for transportation services.

14. The method in accordance with claim 11 wherein relative to a bundle said lodging has a first price, said at least one voucher has a second price and said bundle has a third price which is less than the sum of said first price and said second price.

15. The method in accordance with claim 11 wherein said lodging information comprises room availability and room pricing.

16. The method in accordance with claim 11 wherein said bundle selected by said user has a price and further comprising the step of receiving payment of said price for said bundle selected by said user.

17. The method in accordance with claim 11 further comprising the step of receiving a request to redeem said issued voucher by a service provider in response to presentation of said issued voucher by said user to said service provider.

18. The method in accordance with claim 17 further comprising the step of validating said issued voucher in response to said request to redeem.

19. The method in accordance with claim 11 wherein said at least one voucher associated with each bundle has a maximum redemption value.
